(19) United States
(12) Patent Application Publication
(10) Pub. No.: US 2005/0004822 A1
(43) Pub. Date: Jan. 6, 2005

(54) Method and data processing ssytem for timing the duration of a session

(76) Inventor: Eric Elgrably, Casablanca (MA)

Correspondence Address: Oliff & Berridge, PO Box 19928, Alexandria, VA, 22320, US

(21) Appl. No.: 10/472,850

(22) PCT Filed: Mar. 28, 2002
(86) PCT No.: PCT/NL02/00205

(30) Foreign Application Priority Data
Mar. 28, 2001 (GB) 0107753.6

(51) Int. Cl. G06F 17/60

(52) U.S. Cl. 705/7; 705/11

(57) ABSTRACT

A method of timing the duration of a session during a connection between a user station and a chargeable zone of an Internet site, during which session the user station can access chargeable data and/or services of the site without disconnecting from the Internet, the method comprising: loading a monitoring program into the user station for execution throughout the duration of the session, said monitoring program being configures, while it is being executed, to send information relating to the state of the connection to a time-metering server, said information being renewed periodically throughout the session.

The present invention relates to data transmission networks such as the Internet.

Some operators provide Internet downloading of a Videotex emulator such as a plug-in or a Java applet providing access to Minitel® services in France (see for example the World Wide Web site www.metel.fr at the priority date). Not all Minitel® services can be accessed, and only the services of providers who have entered into an agreement with the operator are offered free of charge.

At present many Internet content or service providers bill Internet surfers after logging their credit card number, for example.

However, many Internet surfers are reluctant to divulge their credit card number over the Internet, even to a secure site.

Also, the costs associated with payment by credit card are not negligible if the amount billed to the Internet surfer is small.

European patent EP 0 885 504 B1 recites a method of billing for data transmission networks. According to this patent, because of the decentralized aspect of the Internet Network, it is very difficult or too expensive to use the usual billing principals:
billing based on the duration of connection between two terminals for a given transmission speed and a given distance,
billing based on the quantity of exchange data between two terminals, as a function of the transmission data speed.

The EP 0 885 504 B1 patent teaches to insert, in the data packets that are transmitted over the Net, a toll heading including a numerical value corresponding to a credit of toll units. Such a method requires working on the communication nodes, so that the billing operation is relatively complex. This method does not bring any solution to bill for duration of connection during an Internet session.

International application WO 00/65 493 describes a method for doing an electronic commerce transaction, in which access certificates are generated by at least one intermediary in order to avoid the transmission of data relative to means of payment over the Internet. No method of billing for duration of connection to a chargeable zone of an Internet site is described.

U.S. Pat. No. 5,794,221 describes a method for establishing an agreement between an Internet access provider and a customer, and an agreement between the Internet access provider and a vendor site of products or services. Once those agreements have been established, the Internet access provider bills the user for the products or services he has bought to the vendor site. This patent does not describe a billing for duration of connection.

International application WO 01/61 592 describes a system only for billing applications software usage offered over the Internet by an application service provider (A.S.P.). This application teaches the possibility of billing for the running of software according to a connect time, but does not describe any method nor system to bill a connection to a chargeable zone of an Internet site, with application of several charging rates and as a function of the duration of connection, capable of being used by a large number of sites and offering sufficient security guaranties. On the contrary, this application recommends a billing system for every running, i.e. adapted to the calculations and operations executed by software when the user asks for.

Thus, there is a need for timing the duration of a session during a connection between a user station and a chargeable zone of an Internet site.

There also exists a need for easier access via the Internet to providers of chargeable contents or services.

Chargeable contents or services may be any content or service which is not freely accessible to any user having access to the network. Chargeable contents or services may be any content or service that can be charged to an individual or a company or any other kind of institution, either directly (for example by sending a bill) or indirectly (for example in exchange for other services or execution of a commercial agreement).

One aspect of the invention is to provide a method of timing the duration of a session during a connection between a user station and a chargeable zone of an Internet site, during which session the user station can access chargeable data and/or services of the site without disconnecting from the Internet, whatever the type of connection (i.g. cable, x-DSL, UMTS, . . . ).

This method may comprise loading a monitoring program into the user station for execution throughout the duration of the session, said monitoring program being configured, while it is being executed, to send information relating to the state of the connection to a time-metering server, said information being renewed periodically throughout the session.

This method may enable Internet sites to offer chargeable data and/or services without dealing with the billing system. Furthermore, a billing for a substantially exact duration of connection may be achieved.

Another advantage may be an easier access for users to chargeable data or services.

During a session, no data concerning means of payment may be transmitted, so that security may be improved.

The information relating to the state of the connection may be transmitted to the time-metering server via a TCP socket connection.

The monitoring program may be contained in a hidden frame.

A hidden frame may be materialized for example by a visible line on the screen of the user station, which may be a personal computer.

The information relating to the state of the connection may be renewed in a period that is shorter than or equal to one minute, for example.

Thus, the monitoring program may inform the time-metering server of the state of the connection at least every minute, or more frequently. The period can be chosen as a function of the nature of the chargeable data or services. For example, in case the user station is connected to a chargeable zone of a site enabling to watch a movie, the period may be longer.

The method may further comprise determining duration for the session, as a function at least of information received by the time-metering server due to execution of the monitoring program.

The duration of the session may be stored by the time-metering server.

A connection duration counter may be incremented each time the time-metering server receives information from the monitoring program.

The monitoring program may be of the Java applet type.

The monitoring program may execute as soon as it is loaded into the user station.

Throughout a session, the user station may periodically receive varying codes of temporary validity as generated by the time-metering server.

Code validity may have duration of not more than three minutes, for example.

The codes may be generated by the time-metering server at substantially constant time intervals.

The number of codes generated during a session may be counted, and the duration of the session may be determined as a function at least of the number of codes counted.

The site may periodically receive varying countersign codes of temporary validity associated with the corresponding varying codes sent to the user station, these countersign codes being generated by the time-metering server, and user station access to the chargeable data and/or services may be authorized so long as the code and the corresponding countersign code satisfy a predetermined relationship, for example an equality relationship.

This may improve security of the connection.

The site may include different pages associated with display temporary addresses.

The monitoring program may be configured to warn the time-metering server in the event of disconnection from the chargeable zone.

A disconnection may for example correspond to a connection to another chargeable zone of the same site, to a connection to another Internet site, to a disconnection from the Internet, intentionally or not or to an interruption of the user station or of the site.

The time-metering server may be arranged to cease timing the session in the event of no information being received from the monitoring program over a predetermined length of time.

The site may be configured so as to associate at least one charging rate with chargeable services and/or data.

The site may include chargeable services and/or data associated with charging rates stored in a database.

The site may include pages organized in directories associated with respective charging rates.

The site may also include pages of addresses that are organized as a function of charging rates, and access to the pages may be performed via a virtual host.

The site may be configured so as to have its own charging rates or/and to apply those that exist on other sites. A program configured so as to introduce information relative to charging rates into the source code of the site may be provided.

The site may include a proxy type program configured to replace an URL address request from the user station with another URL address.

The proxy type program may be configured so as to compare the code with the corresponding countersign code and verify that the predetermined relationship is satisfied.

In one embodiment, the proxy type program may be configured to read information contained in a page sent to the user station, and to transmit said information to the time-metering server. The user station may send information to the time-metering server relating to reception of the page by the user station, and the time-metering server may be configured to compare said information with the information transmitted by the site because of execution of the proxy type program. The time-metering server may be configured to start timing a session on receiving the information relating to reception of the page by the user station. The page may be configured to transmit information to the monitoring program and the monitoring program may be configured to transmit information relating to reception of the page by the user station to the time-metering server.

The site may include pages containing information representative of a charging rate, in particular information that is in tag form.

Information sent by the proxy type program to the time-metering server may comprise a link, the page loaded into the user station may send to the time-metering server a request concerning the link, and this request may constitute information relative to reception of the page by the user station and may start timing a session and/or indicate a charging rate change.

The time-metering server may be arranged to associate at least one charging rate with a chargeable session.

In one embodiment, on each occasion a new page is received by the user station, in particular a new HTML page corresponding to chargeable data and/or service, information relating to said page may be sent to the time-metering server. The information relating to reception of the page by the user station may include charging information.

During a session, information relating to a charging rate associated with a page of the site may be sent to the time-metering server.

A link to access a page may be replaced by a program in javascript type language, this program being configured so as to execute as soon as the user activates the link and to enable the access to the page, this program being also configured so as to send to the monitoring program information relative to the page loading and possibly to the page charging rate. The monitoring program may be configured so as to send the information to the time-metering server.

Content categories may be associated with the charging rates in order to enable to exercise control as a function of age or of parental authorization, for example.

The user station and/or the user may be identified prior to the monitoring program being loaded into the user station.

The user may be identified at least by recognizing a login and a password.

The login and the password may be identical to the login and the password needed to connect to an Internet access supplier.

The user station may be identified by recognizing at least one intrinsic characteristic of the user station.

In case the user station possesses an Ethernet card with a serial number, the user station may be authenticated during an attempt at accessing chargeable services and/or data, at least by reading the serial number.

In case the user station has an IP address, prior to authorizing access to the chargeable zone, the IP address may be compared with one or more prerecorded addresses for identifying the user.

The user may be identified by information coming from Internet access suppliers.

In case the user station is a mobile terminal with a connection linked to an operator, for example one of the types GPRS, UMTS, G3, CDPD, this terminal comprising an identifying chip including a PIN or WIM code, prior to authorizing access to the chargeable zone, the PIN or WIM code may be compared with one or more prerecorded codes for identifying the user.

The user may also be identified with recognition of biometric print, retina, fingerprint, or voice tone.

If the user connects to a chargeable zone of a site, leaves this zone and enter again the zone, identification of the user may not require all identification criteria provided the re-entering of the chargeable zone occurs within a given period of time, for example two hours.

Identification may then request only a password, for example.

The time-metering server may be configured for a given user account to aggregate connection durations to distinct sites, said durations possibly being associated with charging rates.

The duration of the connection to the chargeable zone may be displayed on a screen of the user station.

An amount corresponding to the cost of various connections to the chargeable zones as accumulated over a predetermined period, for example one month, may be displayed on the user station.

The user may be enabled to put an upper limit on expenditure.

The time-metering server may be configured so as to compare the amount corresponding to the cost of various connections to the chargeable zones as accumulated with the upper limit entered by the user, and to warn the user in the event the amount exceeds the upper limit.

A cost associated with the connection to the chargeable tone may be displayed on the user station in a currency (for example USD, EURO, YEN, . . . ) which is a function of a previously-determined place of connection.

The monitoring program may be configured to send information to the time-metering server relating to a data rate at which the user station receives chargeable data. Thus, the user may be charged according to the data received.

The time-metering server may be arranged to issue a bill on a user account associated with a mobile telephone or with a fixed telephone line or with an electricity meter, or with a bank account or with an account associated with a credit card.

The time-metering server may also be configured in such a manner as to enable a user account to be debited for transactions other than for connection time to a chargeable zone of a site.

The connection durations of a plurality of users to chargeable services and/or data of a site may be recorded, and the durations may be subjected to statistical processing. Thus, the site provider may be informed of the time spent by surfers on the various contents or services offered by the site.

The user station may be a personal computer with an Internet connection, for example of the x-DSL type.

The user station may be suitable for communicating over a wireless link with the Internet network.

The site may comprise chargeable contents and/or services of any kind.

The site may comprise chargeable contents such as financial information, meteo, advices, . . .

This site may comprise chargeable services such as presonalized services, providing information upon request, providing audio and video information, . . .

Taking part to a chat forum may also be a chargeable service billed as a function of the duration of connection.

The chargeable service provided by the site may also comprise a vocal interactive service.

The site may include a chargeable service for allocating bandwidth capacity, in order to have a better reception.

The site may comprise a telephone service over the Internet.

The connection to the chargeable zone may be initiated by the user station opening an e-mail sent to the user station, this e-mail including a link to the chargeable zone of the site.

Another aspect of the; invention is to provide a method of enabling a data medium to be used on an appliance, the data medium being configured in such a manner as to prevent at least part of it from being used independently of the appliance being in connection with a chargeable zone of an Internet site. This method comprises:
enabling the appliance to be connected to the chargeable zone of the Internet site;
metering the duration of the connection; and
enabling the medium to be used throughout the time the appliance is connected to the chargeable zone.

The appliance may be for example selected from the following group: a personal computer, a game console (for example of the type XBOX® or PLAYSTATION®), a video projector (for example for a movie theater), an audio and/or video disk player.

The data medium may be for example a cederom, a video disk, for example a DVD, an electronic circuit (for example a memory card), a magnetic band or disk.

Another object of the invention is to provide a time-metering server making it possible, during a connection of a user station to a chargeable zone of an Internet site, to time the duration of a session during which the user station can have access to chargeable data and/or services of the site without disconnecting from the Internet, the server being configured to receive information transmitted by a monitoring program loaded into the user station and being suitable for executing during the session, said monitoring program being configured, on execution, to send information relating to the state of the connection to the time-metering server, this information being renewed periodically during the session.

The time-metering server may be configured to determine the duration of the session, as a function at least of the information it receives because of execution of the monitoring program.

The time metering server may be configured so as to generate variable codes of temporary validity, and to transmit them to the user station.

The time-metering server may be configured to generate varying countersign codes of temporary validity associated with corresponding varying codes sent to the user station, the countersign codes enabling the user station to be authorized to access chargeable data and/or services, so long as the code and the corresponding countersign code satisfy a predetermined relationship.

The time-metering server may be configured to receive information relating to the state of the connection via a TCP socket connection.

The time-metering server may be configured to increment a connection duration counter each time the time-metering server receives information from the monitoring program.

The time-metering server may be configured to cease timing the session in the event of it receiving no information from the monitoring program over a predetermined duration.

The time-metering server may be configured to associate at least one charging rate with a session.

The time-metering server may be configured, for a given user account, to aggregate quantities representative of connection durations to distinct sites, said quantities possibly being associated with charging rates.

The time-metering server may be configured to identify the user station and user by recognizing a login, a password, and at least one intrinsic characteristic of the user station, and when the user station has an Ethernet card with a serial number, the identification may comprise recognizing said serial number.

The time-metering server may be configured to identify the user station by recognizing a PIN or WIM code, the user station being for example a mobile terminal with a connection linked to an operator of one of the types GPRS, UMTS, G3 or CDPD and comprising an identifying chip including a PIN or WIM code.

The time-metering server may be configured, by execution of a proxy type program, to receive information contained in a page sent to the user station, said information being read by the proxy type program from the page or being transmitted by the page to the proxy type program.

Another object of the invention is to provide a computer program referred to as a monitoring program for use during connection of a user station to a chargeable zone of an Internet site in order to time the duration of a session during which the user station can access chargeable data and/or services of the site without disconnection from the Internet, the program being configured so that once loaded into said user station it executes during a chargeable session, said monitoring program being configured so that on execution it sends information relating to the state of the connection to a time-metering server, said information being renewed periodically during the session.

The monitoring program may be configured to renew the information relating to the state of the connection within a period of time that is less than or equal to one minute.

The monitoring program may be a Java type applet.

The monitoring program may be configured to send information to the time-metering server relating to a data rate at which chargeable data is received by the user station.

The monitoring program may be arranged to receive varying codes of temporary validity issued by a time-metering server.

The monitoring program may be arranged to warn the time-metering server in the event of disconnection from the chargeable zone, so that the time-metering server may stop incrementing a duration counter.

Another object of the invention is to provide a signal transmitted over the Internet network, the signal including data readable by a computer and corresponding to the program as defined above being downloaded to a user station.

Another object of the invention is to provide an Internet site including pages corresponding to chargeable services and/or data, the site being configured:
to give a user station access to said pages after the user has been identified; and
to associate each page with a charging rate for billing the time spent consulting the page to a user account associated with the user station.

The site may be configured to receive varying countersign codes of temporary validity from a time-metering server, the countersign codes being generated by the time-metering server and serving to authorize access to the pages by the user station whenever a predetermined relationship is satisfied relative to corresponding codes generated by the time-metering server and sent to the user station.

The site may be configured to compare the countersign code and the corresponding code. This may prevent the site from sending chargeable pages to unauthorized users.

The comparison of the codes and countersign codes may also be carried out by data processing means not included in the site.

The pages may present temporary display addresses. This may prevent users from trying to re-access the pages after the connection. This may also prevent unauthorized users to access chargeable pages without being charged.

Each page may contain information representative of a charging rate, for example in tag form.

The pages may be classified in directories associated with respective charging rates.

The site may include a database in which there are recorded the charging rates corresponding to the chargeable services and/or data.

The site may be configured to transmit charging rates, and/or database update information to the time-metering server.

The site may also be configured to transmit charging rates to the user station.

The site may include a proxy type program.

Another object of the invention is to provide a new data processing system including:
means for accessing a data processing network (for example user stations and servers) which users and chargeable content and/or service providers can log onto, and
memory means (for example data storage systems) for storing account details of each user, which data processing system
enables a user listed by the system and who has been identified to access chargeable data or services of a content and/or service provider without having to specify means of payment directly to said content and/or service provider and
determines the duration of access by the user to the content and/or service provider and possibly the quantity of chargeable data consulted or transferred and possibly the services consumed by the user and
debits the account of the user by a corresponding amount, possibly depending on the nature of said data or services.

It is immaterial who the chargeable content and/or service providers are, and they may be providers of bandwidth or telephone.

Such a data processing system has many advantages.

A first advantage is that it may be possible to access the data processing system from any computer when surfing the Net, because billing of the user is independent of the site which the user has logged onto. Unlike the Minitel® services available in France, for which the telephone subscriber is billed depending on the nature of the service contacted and the duration of contact, the data processing system may enable any Internet surfer using any access provider or operator and any type of connection (PSDN, x-DSL, etc.) to operate from any location to access chargeable services or contents offered by all providers federated around the data processing system, i.e. who have entered into an agreement with the administrator of the data processing system.

It may be the data processing system that assumes responsibility for billing each user, for example depending on the duration of connection to the chargeable content or service provider. Each chargeable content or service provider therefore may have no need to bill the user directly, which avoids the cost of processing a credit card payment in respect of a small amount.

The data provider may create its own charging rates or apply preexisting rates.

The data processing system also enables each user to be debited globally, at the end of a given period or as and when the user consumes, for an amount that corresponds to the total cost of connection to various chargeable content and/or service providers federated around the data processing system. It is highly probable that the amount in question will be non-negligible, which reduces the relative cost of processing a credit card payment.

A further advantage of the data processing system is that it encourages users to consult chargeable content and/or service providers more, because such consultation is possible without the user having to give their credit card number each time.

The data processing system may be adapted to route a user logging onto the data processing system to a particular content or service provider as a function of predetermined criteria. The data processing system may for example select the bandwidth provider that is cheapest at that time of day.

The user account that is debited may be internal to the data processing system, in which case bills are sent directly to the user, not by the data processing system itself but rather through the intermediary of an Internet access provider, for example. The data processing system may bill the access provider who is responsible for recovering the cost from the user.

The data processing network is advantageously the Internet, which is preferably accessed via a high bit rate connection, for example an x-DSL, cable, wireless or satellite connection.

The data processing system may include a Minitel® emulator and provide access to Teletel® via the Professional Access Service [Service d'Accès Professionnel].

The data processing system may include a multi-protocol interface which enables a user to open several sessions at once, each specific to a given protocol, and for example to have on-screen a window corresponding to an Internet session, a window corresponding to a Minitel® session, and a window corresponding to an IBM® 3090 emulator session.

The data processing system may be adapted to apply different charging rates as a function of the identity of the content and/or service providers that the user can access via the system and/or the nature of the contents or services consulted or consumed.

Users may access the data processing system by typing in its Internet address, possibly without first downloading a plug-in.

The invention further provides a method of billing access to a chargeable service or chargeable data depending on the duration of access to said service or data and possibly the quantity of data consulted or transferred and possibly the services consumed, and possibly their nature, said method comprising:
enabling a user to log onto a data processing system having an Internet address,
enabling the user to be listed by the data processing system on specifying means of payment,
enabling the user to log onto a chargeable service and/or content provider via the data processing system after being identified,
enabling the user to benefit from chargeable services and/or data of that service or content provider without having to specify means of payment directly to that content and/or service provider,
determining the duration for which the user accesses the data and/or services of the content and/or service provider and possibly the quantity of data consulted by the user or transferred and possibly the services consumed, in particular in the case of a bandwidth provider, and
debiting, possibly off-line and/or indirectly, an account of the user as a function of that duration and possibly the quantity of data consulted or transferred and possibly the services consumed, possibly allowing for their nature.

The invention will be better understood after reading the following detailed description of non-limiting embodiments of the invention and examining the accompanying drawing, in which:

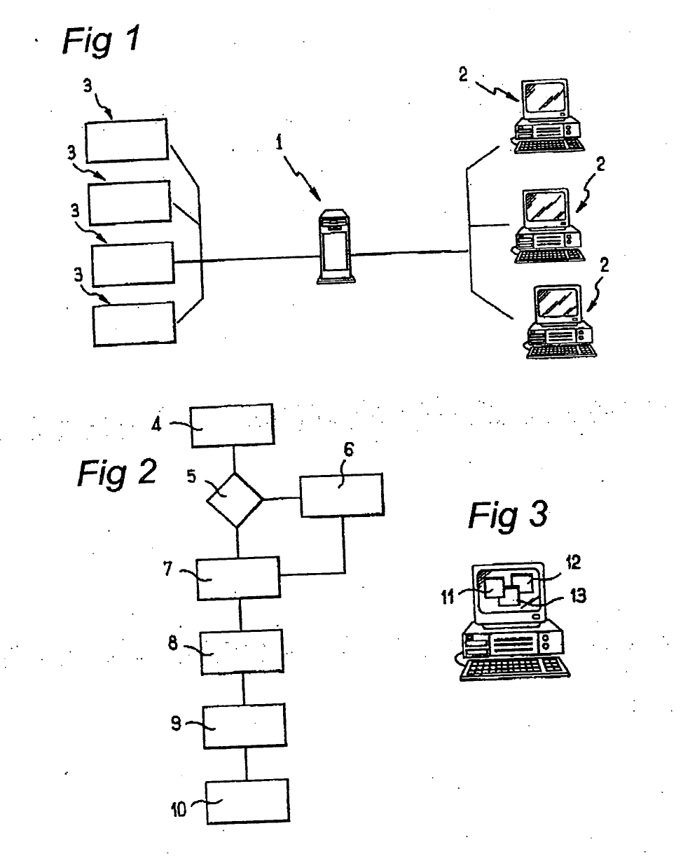

FIG. 1 shows an example of embodiment of the invention,

FIG. 2 is a flow chart,

FIG. 3 shows the simultaneous display of a plurality of windows corresponding to different sessions on the screen of the computer of a user,

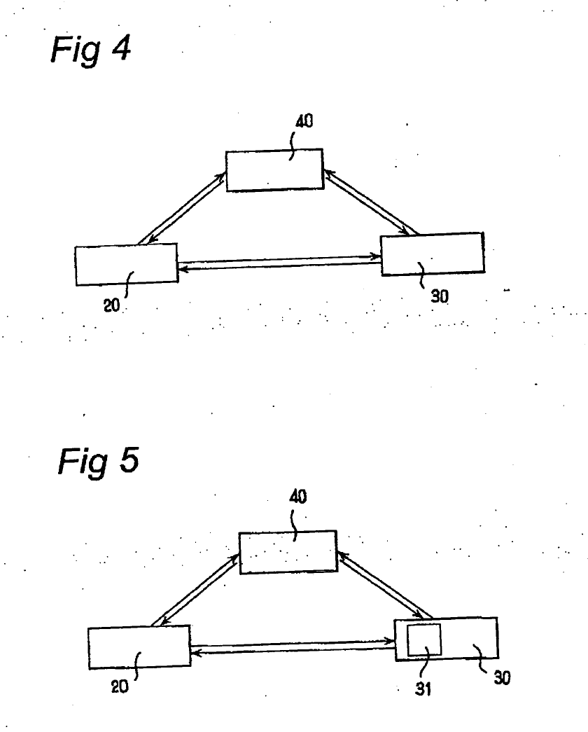

FIG. 4 shows another example of embodiment of the method of the invention, and

FIG. 5 shows another example of embodiment of the method of the invention.

The data processing system 1 shown in FIG. 1 enables users 2, in particular Internet surfers, to benefit form chargeable services and/or data provided by content and/or service providers 3 who are federated around the data processing system 1, i.e. who have entered into agreements with the administrator of the data processing system 1.

The content and/or service providers 3 can provide bandwidth, IP telephone, professional data, emulators, music, films, games or other services for consumers or professionals, for example. The foregoing list is not limiting on the invention.

The data processing system 1 includes means providing access to the content and/or service providers 3 to enable a user to log onto to them indirectly without having to enter into a subscription agreement with each of them or specify to them payment means such as a credit card number.

The data processing system 1 also includes access means enabling users to access the data processing system 1 and identify themselves and, if they are not known to the data processing system 1, to enter sufficient information to be listed, identified and debited, for example a credit card number and the card expiry date, or an identifying code included in a chip comprised in the user station.

The data processing system 1 also manages access rights, in particular when the user is a company and more than one employee of the company can log onto the data processing system 1.

In this case, the data processing system can manage access authorization as a function of the time of day and the names of the company's employees, for example, to prevent an employee accessing the system from home, outside working hours, using the log-in name of the company.

One should refer now to FIG. 2.

In an initial step 4 a user logs onto the data processing system 1 via the Internet using the IP address of the data processing system 1.

In step 5 the data processing system 1 prompts the user to identify himself by entering a log-in name and a password previously selected.

In step 6, if the user is not yet listed he can enter all the necessary information and in particular specify a means of payment, such as a credit card number.

A log-in name and a password are then selected.

In step 7, if the user is already listed and has identified himself adequately, he is allowed to log onto one of the providers 3 federated around the data processing system 1.

In step 8 the data processing system 1 determines the nature of the data and/or the services consulted or consumed and selects the corresponding charging band to be applied.

In step 9 the data processing system 1 measures the duration of the connection and/or the quantity of data transferred or consulted.

In step 10 the data processing system 1 debits the account of the user according to that duration and/or that quantity. In this example the account is a personal account of the user and is directly associated with the means of payment specified to the data processing system.

Alternatively, the account could be internal to the data processing system 1, in which case billing is effected indirectly by an intermediary between the user and the data processing system 1, for example an Internet access provider who has entered into an agreement with the administrator of the data processing system 1.

In the embodiment described, the data processing system 1 includes a multi-protocol interface enabling the user to open more than one window on his screen at a time, the windows corresponding to different sessions, for example, as shown in FIG. 3, a window 11 corresponding to a Minitel® session and a window 13 corresponding to a 3090 emulator session.

If the data processing system 1 can access more than one bandwidth provider 3, the data processing system 1 advantageously connects a user requiring transmitting voice or video automatically to the cheapest bandwidth provider 3 at that time, for the greatest benefit to the user.

The data processing system 1 may be accessed other than via a microcomputer 2, for example by means of a mobile telephone of a pocket organizer, giving an Internet access.

Another example will now be described with reference to FIG. 4.

User station 20 connects to an Internet site 30, comprising a chargeable zone. A time-metering server 40 can exchange information with the user station 20 and Internet site 30.

The user aims for example to access to chargeable pages of the chargeable zone of the Internet site 30.

Before enabling the user station 20 to access those pages, the user station 20 and the user are identified, being asked for example for a login and a password.

In order to authenticate the user station 20 in a more secured manner, the user station's IP address and a serial number of an Ethernet network card, if the user station has one, may be also checked.

Once the user station 20 has been identified, a monitoring program of the java applet type is loaded into the user station 20.

This monitoring program executes as soon as it is loaded, and the user station 20 may access the desired chargeable pages.

The monitoring program is configured so as to, from the beginning until the end of the session of connection of the user station 20 to the chargeable zone of the Internet site 30, send periodically to the time-metering server 40 information relative to the state of the connection. The time-metering server 40 is configured so as to read information received from the monitoring program, in order to increment a connection duration counter (not shown).

The time-metering server 40 generates also codes and countersign codes at substantially constant time intervals. It sends the codes to the user station 20 and the countersign codes to the Internet site 30. The codes and countersign codes are compared, and if they satisfy a predetermined relationship, the user station 20 may access the chargeable zone.

When the user station 20 disconnects from the chargeable zone of the site 30, the monitoring program sends information relative to the end of connection to the time-metering server 40. The time-metering server 40 then ceases timing the session.

In case the user station 20 connects several times to a chargeable zone of Internet site 30, the time-metering server 40 may aggregate connection duration of several sessions, in order to establish a global billing for all the sessions. Several Internet sites may comprise chargeable zones the user station can connect to as described before. All durations of all sessions of connection to all chargeable zones of several Internet sites may be aggregated by the time-metering server 40.

In a same chargeable zone, chargeable data and/or services may be associated to different charging rates.

These chargeable data or services may correspond to pages, for example HTML pages, transmitted to the user station 20. These pages may contain information representative of a charging rate, in particular information in tag form. The monitoring program may be configured so as to send to the time-metering server 40 information related to those tags, the time-metering server 40 taking into account the charging rates when billing the user station 20.

FIG. 5 shows an Internet site 30 comprising a proxy type program 31. The proxy type program 31 is in charge of replacing an URL address requested by the user station 20 by another URL address. The proxy type program 31 is also configured so as to read information contained in the pages sent to the user station 20 by the site 30 and to send this information to the time-metering server 40. The user station 20 sends to the time-metering server 40 information relative to reception of the chargeable page of the site 30 and the time-metering server 40 is configured so as to compare this information with the information transmitted by the site 30 because of execution of the proxy type program 31.

When the information received by the time-metering server (40) satisfy a predetermined relationship, a connection duration counter is incremented. The information send by the proxy type program 31 may contain information representative of a charging rate.

Information contained in the pages sent to the user station say be transmitted to the time-metering server 40 through the monitoring program loaded on the user station.

It may also be possible according to one aspect of the invention to trace an identified user using a user station made of a mobile terminal throughout a connection to a low rate chargeable zone of an Internet site, even if there are one or more disconnections throughout the session.

The following example relates to a method enabling the traceability of the user station and of the actions of the user throughout the session.

For example, a user enters a supermarket. He connects his mobile terminal to a chargeable zone of a site, identifies himself, and begins shopping. The trolley is configured to detect and calculate the price of the items put therein. From the beginning of the session until the end of the session, the user is known, identified and traced. Once the user has finished shopping, he gives, with help of his mobile terminal, an order to pay the items contained in the trolley. Then, he receives for example a code authorizing him to leave the supermarket and the session ends.

Of course, the invention is not limited to the examples that have been described.

Features of all embodiments described, both without reference to the drawings and with reference to the drawings may be combined together.

1-102. cancelled.

103. A method of timing the duration of a session during a connection between a user station and a chargeable zone of an Internet site, during which session the user station can access at least one of chargeable data and chargeable services of the site without disconnecting from the Internet, the method comprising:
loading a monitoring program into the user station for execution throughout the duration of the session, said monitoring program being configured, while it is being executed, to send information relating to the state of the connection to a time-metering server, said information being renewed periodically throughout the session.

104. A method according to claim 103, wherein the information relating to the state of the connection is transmitted to the time-metering server via a TCP socket connection.

105. A method according to claim 103, wherein the monitoring program is contained in a hidden frame.

106. A method according to claim 103, wherein the information relating to the state of the connection is renewed in a period that is shorter than or equal to one minute.

107. A method according to claim 103, wherein further comprising determining a duration for the session, as a function at least of information received by the time-metering server due to execution of the monitoring program.

108. A method according to claim 103, wherein the monitoring program is of the Java applet type.

109. A method according to claim 103, wherein the monitoring program executes as soon as it is loaded into the user station.

110. A method according to claim 103, wherein at least one of the user station and the user is identified prior to the monitoring program being loaded into the user station.

111. A method according to claim 103, wherein throughout a session, the user station periodically receives varying codes of temporary validity as generated by the time-metering server.

112. A method according to claim 111, wherein code validity has a duration of not more than three minutes.

113. A method according to claim 111, wherein the codes are generated by the time-metering server at substantially constant time intervals.

114. A method according to claim 111, wherein the number of codes generated during a session is counted, and wherein the duration of the session is determined as a function at least of the number of codes counted.

115. A method according to claim 111, wherein the site periodically receives varying countersign codes of temporary validity associated with the corresponding varying codes sent to the user station, these countersign codes being generated by the time-metering server, and wherein user station access to the at least one of chargeable data and chargeable services is authorized so long as the code and the corresponding countersign code satisfy a predetermined relationship.

116. A method according to claim 115, wherein the predetermined relationship is an equality relationship.

117. A method according to claim 103, wherein a connection duration counter is incremented each time the time-metering server receives information from the monitoring program.

118. A method according to claim 103, wherein the site includes different pages associated with display temporary addresses.

119. A method according to claim 103, wherein the monitoring program is configured to warn the time-metering server in the event of disconnection from the chargeable zone.

120. A method according to claim 103, wherein the time-metering server is arranged to cease timing the session in the event of no information being received from the monitoring program over a predetermined length of time.

121. A method according to claim 103, wherein the site is configured so as to associate at least one charging rate with at least one of chargeable services and chargeable data.

122. A method according to claim 121, wherein the site includes at least one of chargeable services and chargeable data associated with charging rates stored in a database.

123. A method according to claim 122, wherein the database is stored with the site supplier or with the time-metering server.

124. A method according to claim 121, wherein the site includes pages organized in directories associated with respective charging rates.

125. A method according to claim 121, wherein the site includes pages of addresses that are organized as a function of charging rates, and wherein access to the pages is performed via a virtual host.

126. A method according to claim 103, wherein the site includes a proxy type program serving to replace an URL address request from the user station with another URL address.

127. A method according to claim 126, wherein the proxy type program is configured so as to compare the code with the corresponding countersign code and verify that the predetermined relationship is satisfied.

128. A method according to claim 126, wherein the proxy type program is configured to read information contained in a page sent to the user station and to transmit said information to the time-metering server.

129. A method according to claim 128, wherein the user station sends information to the time-metering server relating to reception of the page, and wherein the time-metering server is configured to compare said information with the information transmitted by the site because of execution of the proxy type program.

130. A method according to claim 129, wherein the time-metering server is configured to start timing a session on receiving the information relating to reception of the page by the user station.

131. A method according to claim 129, wherein the page is arranged to transmit information to the monitoring program and wherein the monitoring program is configured to transmit information relating to reception of the page to the time-metering server.

132. A method according to claim 103, wherein the site includes pages containing information representative of a charging rate, in particular information that is in tag form.

133. A method according to claim 129, wherein the information sent by the proxy type program to the time-metering server comprises a link, wherein the page loaded into the user station sends to the time-metering program a request concerning the link, and wherein this request constitutes information relative to reception of the page by the user station and at least one of starts timing a session and indicates a charging rate change.

134. A method according to claim 103, wherein on each occasion a new page is received by the user station, in particular a new HTML page corresponding to at least one of chargeable data and chargeable service, information relating to said page is sent to the time-metering server.

135. A method according to claim 103, wherein a link to access to a page is replaced by a program in javascript type language, this program being configured to execute as soon as the user activates the link and enable the access to the page, this program being also configured so as to send to the monitoring program information relative to the page loading and possibly to the page charging rate.

136. A method according to claim 135, wherein the monitoring program is configured so as to send said information to the time-metering server.

137. A method according to claim 103, wherein content categories are associated with the charging rates in order to enable to exercise control as a function of age or of parental authorization.

138. A method according to claim 103, wherein at least one of the user station and the user is identified, at least by recognizing a login and a password.

139. A method according to claim 138, wherein the login and the password are identical to the login and the password needed to connect to an Internet access supplier.

140. A method according to claim 103, wherein at least one of the user station and the user is identified by recognizing at least one intrinsic characteristic of the user station.

141. A method according to claim 103, in which the user station has an IP address, and wherein, prior to authorizing access to the chargeable zone, said fP address is compared with one or more prerecorded addresses for identifying the user.

142. A method according to claim 103, wherein the user is identified by information coming from Internet access suppliers.

143. A method according to claim 103, wherein the user station is a mobile terminal with a connection linked to an operator of one of the types GPRS, UMTS, G3, CDPD, this terminal comprising an identifying chip including a code PIN or WIM, and wherein, prior to authorizing access to the chargeable zone, said code PIN or WIM is compared with one or more prerecorded codes for identifying the user.

144. A method according to claim 103, wherein the time-metering server is configured for a given user account to aggregate connection durations to distinct sites, said durations possibly being associated with charging rates.

145. A method according to claim 103, wherein the duration of the connection to the chargeable zone is displayed on the user station.

146. A method according to claim 103, wherein the time-metering server is configured to compare the amount corresponding to the cost of various connections to the chargeable zones as accumulated with an upper limit on expenditure entered by the user, and to warn the user in the event the cost exceeds the upper limit on expenditure.

147. A method according to claim 103, wherein the monitoring program is configured to send information to the time-metering server relating to a data rate at which the user station receives chargeable data.

148. A method according to claim 103, wherein the connection durations of a plurality of users to at least one of chargeable services and chargeable data of a site are recorded, and wherein said durations are subjected to statistical processing.

149. A method according to claim 103, wherein the user station is a personal computer with an Internet connection, in particular of the xDSL type.

150. A method according to claim 103, wherein the user station is suitable for communicating over a wireless link with the Internet network.

151. A method according to claim 103, wherein the time-metering server is arranged to issue a bill on a user account associated with a mobile telephone or with a fixed telephone line or with an electricity meter, or with a bank account or with an account associated with a credit card.

152. A method according to claim 103, wherein the time-metering server is configured in such a manner as to enable a user account to be debited for transactions other than for connection time to a chargeable zone of a site.

153. A method according to claim 103, wherein the site includes a chargeable service for allocating bandwidth capacity.

154. A method according to claim 103, wherein the connection to the chargeable zone is initiated by the user station opening an e-mail sent to the user station and including a link to the chargeable zone of the site.

155. A method of enabling a data medium to be used on an appliance, the data medium being configured in such a manner as to prevent at least part of it from being used independently of the appliance being in connection with a chargeable zone of an Internet site, comprising:
enabling the appliance to be connected to the chargeable zone of the Internet site;
metering the duration of the connection; and
enabling the medium to be used throughout the time the appliance is connected to the chargeable zone.

156. A method according to claim 155, wherein the appliance is selected from the following group: a personal computer, a games console, a video projector, a reader of at least one of audio and video disks.

157. A computer program referred to as a monitoring program for use during connection of a user station to a chargeable zone of an Internet site in order to time the duration of a session during which the user station can access to least one of chargeable data and chargeable services of the site without disconnection from the Internet, the program being configured so that once loaded into said user station it executes during a chargeable session, said monitoring program being configured so that on execution it sends information relating to the state of the connection to a time-metering server, said information being renewed periodically during the session.

158. A program according to claim 157, said program being configured to renew the information relating to the state of the connection within a period of time that is less than or equal to one minute.

159. A program according to claim 157, said program being a Java type applet.

160. A program according to claim 157, said program being configured to send information to the time-metering server relating to a data rate at which chargeable data is received by the user station.

161. A program according to claim 157, said program being arranged to receive varying codes of temporary validity issued by a time-metering server.

162. A program according to claim 157, said program being arranged to warn the time-metering server in the event of disconnection from the chargeable zone.

163. A program according to claim 157, said program being configured to identify the user station by recognizing a PIN or WIM code, the user station being a mobile terminal with a connection linked to an operator of one of the types GPRS, UMTS, G3 pr CDPD and comprising and identifying chip including a PIN or WIM code.

164. A signal transmitted over the Internet network, the signal including data readable by a computer and corresponding to the program as defined in claim 55 being downloaded to a user station.

165. A data processing system including:
means for accessing a data processing network which users and at least one of chargeable content and chargeable service providers can log onto, and
memory means for storing account details of each user, which data processing system enables a user listed by the system and who has been identified to access chargeable data or services of at least one of a content and a service provider without having to specify means of payment directly to said at least one of content and service provider and determines the duration of access by the user to the at least of one content and service provider and possibly the quantity of chargeable data consulted or transferred and possibly the services consumed by the user and debits the account of the user by a corresponding amount, possibly depending on the nature of said data or services.

166. A system according to claim 165, wherein said data processing network is the Internet and is preferably accessed via a high bit rate connection, in particular an x-DSL or satellite connection.

167. A system according to claim 165, said system applying different charge bands according to at least one of:
the identity of the at least one of content and service providers that a user can access via said system, and
the nature of the contents or services consulted or consumed.

168. A system according to claim 165, wherein it can be accessed by means of an Internet address, possibly without previously downloading a plug-in.

169. A system according to claim 165, wherein the data processing system is adapted to route a user logging onto the data processing system to a particular content or service provider as a function of predetermined criteria.
